(19) United States
(12) Patent Application Publication
(10) Pub. No.: US 2019/0203753 A1
(43) Pub. Date: Jul. 4, 2019

(54) CONNECTION TUBE FOR POWER TOOL

(71) Applicant: JYEN HERR ENTERPRISE CO., LTD., Changhua City (TW)

(72) Inventor: Kevin Yao, Changhua City (TW)

(73) Assignee: JYEN HERR ENTERPRISE CO., LTD., Changhua City (TW)

(21) Appl. No.: 15/856,954

(22) Filed: Dec. 28, 2017

(51) Int. Cl. F16B 7/04; A01G 3/053

(52) U.S. Cl. CPC F16B 7/0413; A01G 3/0535

(57) ABSTRACT

A connection tube for a power tool, adapted to be engaged with and disposed inside a sleeve tube of the power tool is disclosed. The connection tube is characterized in that: at least one first section and at least one second section are formed on an exterior surface of the connection tube; the at least one section is a curved surface located at a periphery of a first imaginary circle which could be joined to an interior surface of the sleeve tube when the connection tube is engaged with the sleeve tube, and the at least one second section is a convex-concave structure having a plurality of first hill portions and a plurality of first valley portions which are alternatively arranged, wherein crests of the first hills do not exceed the periphery of the first imaginary circle.

### BACKGROUND OF THE INVENTION

### Technical Field

The present invention relates to a connection tube, and more particularly relates to a connection tube for a power tool.

### Description of Related Art

With improvements on the industrial technology, conventional manual pruning tools used for garden pruning operations have been gradually replaced by power tools which could be driven by motors. Typically, garden-pruning power tools could be divided into cart-type power tools and portable-type power tools. Sine the portable-type power tools have high maneuverability and low manufacturing cost, the portable-type power tools have been widely used in garden pruning operations.

For instance, a conventional power tool 100 which is frequently used for pruning branches and leaves of trees is disclosed, which includes a connection tube 110, a switch 120, a tool 130, a power supply 140 and a driving shaft (not shown), wherein the switch 120 and the tool 130 are respectively disposed on two ends of the connection tube 11; the power supply 140 (e.g. a motor) is connected to another side of the switch 120; the driving shaft is mounted within the connection tube 110 and adapted to connect the power supply 140 and the tool 130, whereby a user could control the switch 120 to turn on/off the power supply 140 to drive the driving shaft to make the tool 130 reciprocate in straight line in order to achieve the purpose for pruning branches and leaves of trees.

The connection tube 110 of the conventional power tool, such as the connection tube disclosed by Taiwan Design Patent number D169103, includes an exterior surface having annularly arranged concave-convex structure which enables a friction to be increased when the user grips the connection tube 110, so that the connection tube 110 is not easy to slip from the user's hand and the operation safety is improved. In addition, the above structure could reduce a total weight of the connection tube 110 without decreasing the physical strength of the connection tube 110 and ease the operation load on the user.

However, as illustrated in FIG. 2, the connection tube 110 is usually inserted into and tightly abut against a sleeve tube 120A which is connected to the switch 120. When the power tool 100 is powered on to operate, the connection tube 110 would generate a reciprocating vibration in a predetermined direction W1, i.e., the reciprocating vibration is usually perpendicular to the ground, such that part of the exterior surface the connection tube 110 which is on or close to the predetermined direction would be gradually worn down due to the long-time vibration, which could further forms a gap between the part of the connection tube being located on the predetermined direction and the sleeve tube 120A, resulting in a safety concern that the connection tube 110 might be loosen from the sleeve tube 120A. Therefore, the structure design of the conventional connection tube 100 is not perfect and still needs more improvements.

### BRIEF SUMMARY OF THE INVENTION

In view of the above, an object of the present invention is to provide a connection tube for a power tool which not only could increase friction and be lightweight, but also would not be less likely to be worn, which could prevent the connection tube from being loosen and increase the operation safety.

The prevent invention provides a connection tube for a power tool, adapted to be engaged with and disposed within a sleeve tube of the power tool, wherein the connection tube is characterized in that: at least one first section and at least one second section are formed on an exterior surface of the connection tube; the at least one section is a curved surface located at a periphery of a first imaginary circle which could be joined to an interior surface of the sleeve tube when the connection tube is engaged with the sleeve tube, and the at least one second section is a convex-concave structure having a plurality of first hill portions and a plurality of first valley portions which are alternatively arranged, wherein crests of the first hills do not exceed the periphery of the first imaginary circle. Preferably, the crests of the first hills are on the periphery of the first imaginary circle.

According to an embodiment of the present invention, the at least one third section and the at least one fourth section are formed on an interior surface of the connection tube; the at least one third section is a curved surface and located on a periphery of a second imaginary circle; the at least one fourth section is a convex-concave structure having a plurality of second hill portions and a plurality of second valley portions which are parallel to each other and are alternatively arranged; crests of the plurality of second valley portions do not exceed the periphery of the second imaginary circle. Preferably, the crests of the plurality of second valley portions are on the periphery of the second imaginary circle.

According to an embodiment of the present invention, the at least one third section is disposed on the interior surface of the connection tube which corresponds to the at least one second section, and the fourth section is disposed on the interior surface of the connection tube which corresponds to the at least one first section.

According to an embodiment of the present invention, a portion of the interior surface of the connection tube which corresponds to the at least one first section is formed with the fourth section, and a portion of the interior surface of the connection tube which corresponds to the at least one second section is formed with the third section.

According to an embodiment of the present invention, a length of the peripheral section of the first imaginary circle which corresponds to the at least one first section is between 20% to 80%, preferably 50% of the circumference of the first imaginary circle, and a length of the peripheral section of the first imaginary circle which corresponds to the at least one second section is between 80% to 20%, preferably 50% of the circumference of the first imaginary circle.

According to an embodiment of the present invention, a length of the peripheral section of the second imaginary circle which corresponds to the at least one third section is between 20% to 80%, preferably 50% of the circumference of the second imaginary circle, and a length of the peripheral section of the second imaginary circle which corresponds to the at least one fourth section is between 80% to 20%, preferably 50% of the circumference of the second imaginary circle.

According to an embodiment of the present invention, the peripheral section of the first imaginary circle which corresponds to the at least one first section has a total central angle of 72 to 288 degrees, preferably 180 degrees, and the peripheral section of the first imaginary circle which corresponds to the at least one second section has a total central angle of 288 to 72 degrees, preferably 180 degrees.

According to an embodiment of the present invention, the peripheral section of the second imaginary circle which corresponds to the at least one third section has a total central angle of 72 to 288 degrees, preferably 180 degrees, and the peripheral section of the second imaginary circle which corresponds to the at least one fourth section has a total central angle of 288 to 72 degrees, preferably 180 degrees.

According to an embodiment of the present invention, when the connection tube is engaged with the sleeve tube of the power tool, and the power tool operates to generate a reciprocating vibration in a predetermined direction, the at least one first section is at the predetermined direction, while the at least one second section is not at the predetermined direction.

By utilizing the above design, the power tool of the present invention not only could increase friction and be lightweight, but also would not be less likely to be worn, which could prevent the connection tube from being loosen and increase the operation safety.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of a conventional power tool;

FIG. 2 is a cross-sectional view of a connection tube of the conventional power tool;

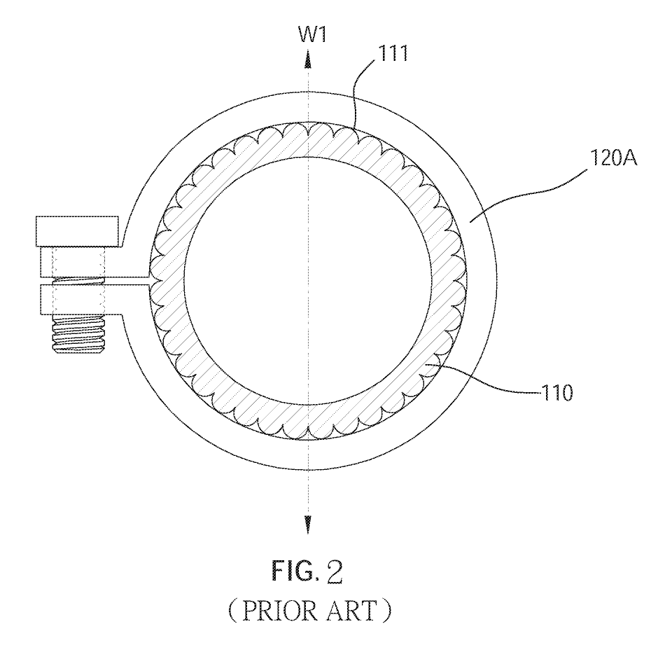

FIG. 3 is a perspective view of a connection tube for a power tool according to a first embodiment of the present invention;

FIG. 4 is a cross-sectional view of the connection tube for a power tool according to a first embodiment of the present invention;

FIG. 5 is a cross-sectional view showing the connection tube of FIG. 4 is engaged with a sleeve tube;

FIG. 6 is a cross-sectional view of a connection tube for a power tool according to a second embodiment of the present invention; and

FIG. 7 is a cross-sectional view of a connection tube for a power tool according to a third embodiment of the present invention.

### DETAILED DESCRIPTION OF THE INVENTION

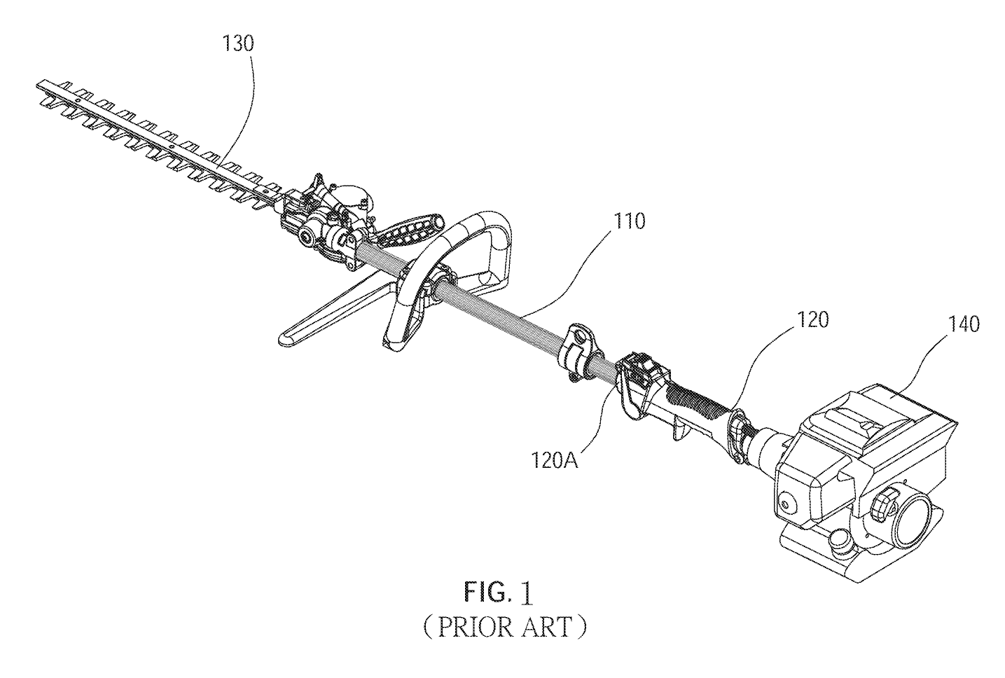

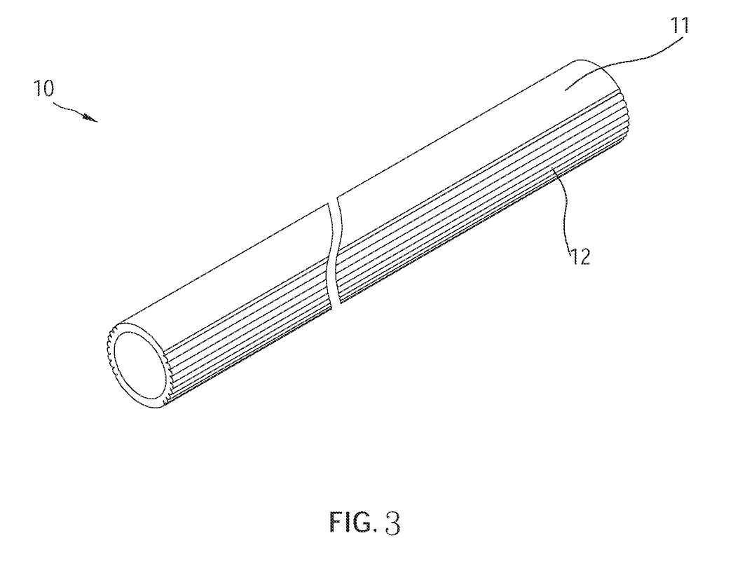

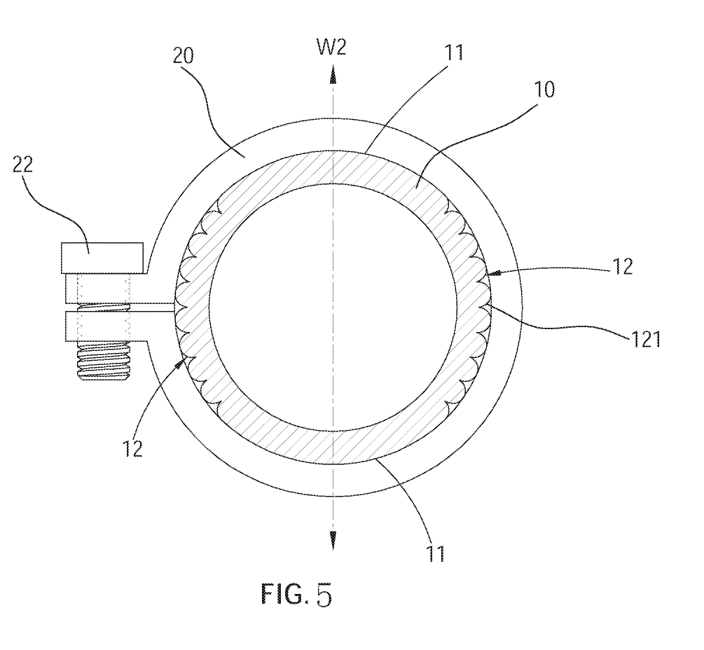

The following illustrative embodiments and drawings are provided to illustrate the disclosure of the present invention, these and other advantages and effects can be clearly understood by persons skilled in the art after reading the disclosure of this specification. As illustrated in FIG. 3 to FIG. 5, a connection tube 10 of an embodiment of the present embodiment according to the present invention is adapted to be engaged with a sleeve tube 20 of a power tool (not shown). The connection tube 10 is inserted into the sleeve tube 20 and could be tightly secured in the sleeve tube 20 by fastening a bolt 22 to the sleeve tube 20. Except the connection tube 10, the other structures of the power tool mentioned above is related to conventional arts, which could refer to the configuration of the conventional power tool shown in FIG. 1 or other types of power tools (e.g. the power tools manufactured by Team Machinery Co., Ltd., Model: EBC-2401, EBC-240D, EBC-240MT, EBC-240W, APT-240, S-400, S-400JT, V-600, V-800, X-600, X-600D, X-800D, X-800W, BP-269, KT-350 or KT-430), and therefore the descriptions of the details are omitted here. The characteristic of the present invention relates to a structure design of the connection tube 10, which would be described as follows.

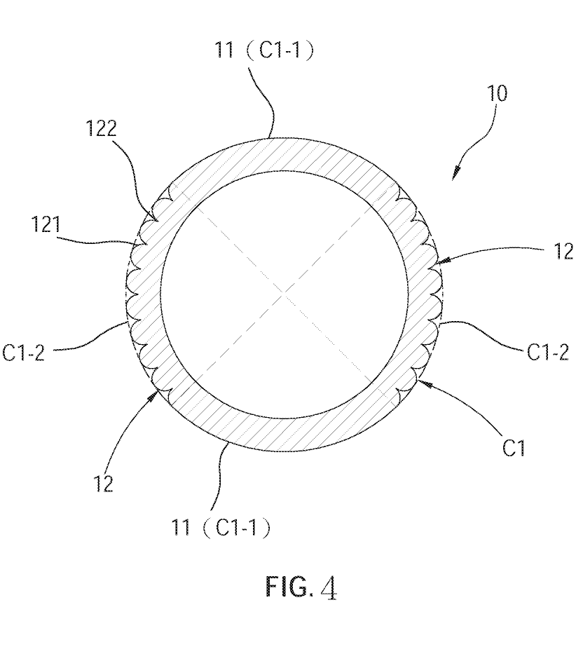

As illustrated in FIG. 3 and FIG. 4, in the current embodiment, an exterior surface of the connection tube 10 includes two first sections 11 and two second sections 12 which are alternatively arranged to surround a periphery of the connection tube 10. Each of the first sections 11 is a smooth curved surface which is located on a periphery of a first imaginary circle C1, and each of the second section includes a convex-concave structure having a plurality first hill portions 121 and a plurality of first valley portions 122 which are parallel to each other and alternatively arranged, wherein a crest of each of the first hill portions 121 do not exceed the periphery of the first imaginary circle C1. In the current embodiment, the crests of the first hill portions 121 are tangential to the periphery of the first imaginary circle C1, i.e., are located on the periphery of the first imaginary circle C1.

Furthermore, in the current embodiment, the first sections 11 and the second sections 12 are arranged with regular intervals on the exterior surface of the connection tube 10. More detail, a peripheral section C1-1 of the first imaginary circle C1 which corresponds to the first sections 11 has a length equal to half of the circumference of the first imaginary circle C1, and a peripheral section C1-2 of the first imaginary circle C1 which corresponds to the second sections 12 also has a length equal to half of the circumference of the first imaginary circle C1 as well. In other words, the peripheral section C1-1 which corresponds to the first sections 11 has a total central angle of 180 degrees, and the peripheral section C1-2 which corresponds to the second sections 12 also has a total central angle of 180 degrees.

In this way, with the aforementioned design, the exterior of the connection tube 10 still could be a suitable surface which has friction to prevent a user' hand from slipping when the user grips the connection tube 10. Meanwhile, the user could make the first sections 11 of the connection tube 10 be aligned to a top and a bottom of the interior portion of the sleeve tube 20, and make the second sections 12 be disposed with respect to a left and a right sides of the interior surface of the sleeve tube 20 respectively when the user installs the connection tube 10 to the sleeve tube 20, whereby the first sections 11 could be joined to the interior surface of the sleeve tube 20 tightly, and the crests of the first hill portions 121 could abut against the interior surface of the sleeve tube 20. Whereby, when the power tool operates to generate a reciprocating vibration in a predetermined direction W2, i.e., the reciprocating vibration is perpendicular to the ground, the first sections 11 would be at the predetermined direction W2 and is to be joined with the interior surface of the sleeve tube 20, while the second sections 12 would not be at the predetermined direction W2, and thereby could prevent the exterior surface of the connection tube 10 from being worn down and could increase the service life of the connection tube 10. In addition, with the design that the crests of the first hill portions 121 of the second sections 12 abut against the interior surface of the sleeve tube 20, it could further prevent the connection tube 10 from being loosen after connection so as to improve the operation safety. Moreover, the structure design of the second sections 12 also could reduce a total weight of the connection tube 10 without decreasing physical strength thereof, which could greatly ease an operation load on the user.

In other embodiments, a distribution ratio of the first sections and the second sections also could be modified to obtain the same result. For instance, a length of the peripheral section of the first imaginary circle C1 which corresponds to the first sections could be modified to be 20% to 80% of the circumference of the first imaginary circle C1, and a length of the peripheral section of the first imaginary circle C1 which corresponds to the second sections could be modified to be 80% to 20% of the circumference of the first imaginary circle C1, wherein a total length of the corresponding peripheral sections of the first sections and the second sections is smaller than or equal to the peripheral section of the first imaginary circle C1, depending on the requirement. That is, the peripheral section of the first imaginary circle C1 which corresponds to the first sections could have a total central angle of 72 to 288 degrees, and the peripheral section of the first imaginary circle C1 which corresponds to the second sections could have a total central angle of 288 to 72 degrees, wherein a sum of the central angles of the peripheral sections of the first imaginary circle C1 which correspond to the first sections and the second sections could be smaller than or equal to 360 degrees.

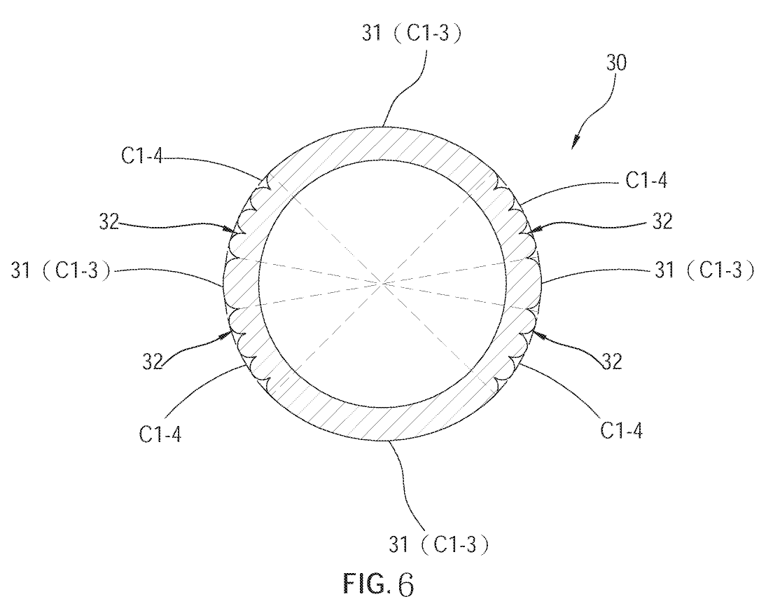

A connection tube 30 of a second embodiment according to the present invention is shown in FIG. 6, which has almost the same structure as the connection tube of the first embodiment, wherein the first sections 31 and the second sections 32 are not arranged with regular intervals, and a distribution ratio of the first sections 31 is greater than that of the second sections. More detail, the peripheral section C1-3 of the first imaginary circle C1 which corresponds to the first sections 31 has a length of ⅔ of the circumference of the first imaginary circle C1, i.e., the peripheral section C1-3 of the first imaginary circle C1 which corresponds to the first sections 31 has a total central angle around 240 degrees. In other words, the peripheral section C1-4 of the first imaginary circle C1 which corresponds to the second sections 32 has a shortened length which is equal to ⅓ of the circumference of the first imaginary circle C1, i.e., the peripheral section C1-4 of the first imaginary circle C1 which corresponds to the second sections 32 has a total central angle around 120 degrees. With the above design on the distribution of the first sections 31 and the second sections 32, the connection tube 30 still has the advantage of an improvement on gripping friction, being not easy to be worn down, light weight and a firm structure.

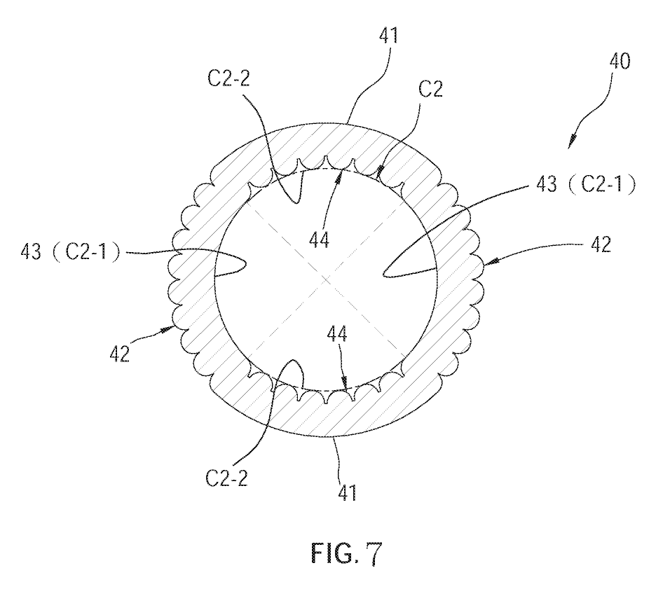

Furthermore, in order to realize the light weight function, a connection tube 40 of a third embodiment according to the present invention is shown in FIG. 7, which has almost the same structure of the connection tube of the first embodiment, wherein two third sections 43 and two fourth sections 44 are arranged with regular intervals on an interior surface of the connection tube 40. Each of the third sections 43 is a smooth curved surface and located at a periphery of a second imaginary circle C2, and each of the fourth sections 44 includes a convex-concave structure having a plurality second hill portions and a plurality of second valley portions which are parallel to each other and alternatively arranged, wherein a crest of each of the second hill portions does not exceed the periphery of the second imaginary circle C2. In the current embodiment, the crests of the second hill portions are tangential to the periphery of the second imaginary circle C2, i.e., are located on the periphery of the second imaginary circle C2.

The fourth sections on the interior surface of the connection tube 40 is corresponding to the first sections 41 on the exterior surface of the connection tube 40, and the second sections on the exterior surface of the connection tube 40 is corresponding to the third sections 41 on the interior surface of the connection tube 40. That is, the third sections 43 are located on the interior surface at positions which are corresponding to the positions of the second section 22, and the fourth sections 44 are located on the interior surface at positions which are corresponding to the first sections 41. Besides, the third sections 43 and the fourth sections 44 are arranged on the interior surface of the connection tube 40 with regular intervals. More detail, a peripheral section of the second imaginary circle C2 which corresponds to the third sections 43 has a length equal to half of the circumference of the second imaginary circle C2 (50%), and a peripheral section of the second imaginary circle C2 which corresponds to the fourth sections 43 has a length equal to half of the circumference of the second imaginary circle C2 (50%) as well. In other words, the peripheral section C2-1 which corresponds to the third sections 43 has a total central angle of 180 degrees, and the peripheral section C2-2 which corresponds to the fourth sections 44 also has a total central angle of 180 degrees.

In this way, with the structure design of the third sections 43 and the fourth sections 44, it could greatly reduce a total weight of the connection tube 10 without decreasing physical strength thereof, which could greatly ease an operation load on the user. In other embodiments, a distribution ratio of the third sections and the fourth sections could be modified as the method for modifying the first sections and the second sections of the aforementioned embodiments to obtain the same advantage, and therefore the detail descriptions are omitted here. For instance, the imaginary circles of the above embodiments are round circles as an example. However, in other embodiments, the imaginary circles also could be an ellipse depending on the device or structure design requirements.

It must be pointed out that the embodiments described above are only some embodiments of the present invention. All equivalent structures which employ the concepts disclosed in this specification and the appended claims should fall within the scope of the present invention.

What is claimed is:

1. A connection tube for a power tool, adapted to be engaged with a sleeve tube of the power tool, wherein the connection tube is to be inserted into the sleeve tube, the connection tube is characterized in that:
at least one first section and at least one second section are formed on an exterior surface of the connection tube; the at least one section is a curved surface located at a periphery of a first imaginary circle which could be joined to an interior surface of the sleeve tube when the connection tube is engaged with the sleeve tube, and the at least one second section is a convex-concave structure having a plurality of first hill portions and a plurality of first valley portions which are alternatively arranged, wherein crests of the first hills do not exceed the periphery of the first imaginary circle.

2. The connection tube of claim 1, wherein the crests of the first hill portions are located on the periphery of the first imaginary circle.

3. The connection tube of claim 1, wherein at least one third section and at least one fourth section are formed on an interior surface of the connection tube; the at least one third section is a curved surface and located on a periphery of a second imaginary circle; the at least one fourth section is a convex-concave structure having a plurality of second hill portions and a plurality of second valley portions which are parallel to each other and are alternatively arranged; crests of the plurality of second valley portions do not exceed the periphery of the second imaginary circle.

4. The connection tube of claim 3, wherein the crests of the plurality of second hill portions are located on the second imaginary circles.

5. The connection tube of claim 3, wherein the at least one third section is disposed on the interior surface of the connection tube which corresponds to the at least one second section, and the fourth section is disposed on the interior surface of the connection tube which corresponds to the at least one first section.

6. The connection tube of claim 3, wherein a portion of the interior surface of the connection tube which corresponds to the at least one first section is formed with the fourth section, and a portion of the interior surface of the connection tube which corresponds to the at least one second section is formed with the third section.

7. The connection tube of claim 1, wherein a length of the peripheral section of the first imaginary circle which corresponds to the at least one first section is between 20% to 80% of the circumference of the first imaginary circle, and a length of the peripheral section of the first imaginary circle which corresponds to the at least one second section is between 80% to 20% of the circumference of the first imaginary circle.

8. The connection tube of claim 7, wherein the length of the peripheral section of the first imaginary circle which corresponds to the at least one first section is 50% of the circumference of the first imaginary circle, and the length of the peripheral section of the first imaginary circle which corresponds to the at least one second section is 50% of the circumference of the first imaginary circle.

9. The connection tube of claim 3, wherein a length of the peripheral section of the second imaginary circle which corresponds to the at least one third section is between 20% to 80% of the circumference of the second imaginary circle, and a length of the peripheral section of the second imaginary circle which corresponds to the at least one fourth section is between 80% to 20% of the circumference of the second imaginary circle.

10. The connection tube of claim 9, wherein the length of the peripheral section of the second imaginary circle which corresponds to the at least one third section is 50% of the circumference of the second imaginary circle, and the length of the peripheral section of the second imaginary circle which corresponds to the at least one fourth section is 50% of the circumference of the second imaginary circle.

11. The connection tube of claim 1, wherein the peripheral section of the first imaginary circle which corresponds to the at least one first section has a total central angle of 72 to 288 degrees, and the peripheral section of the first imaginary circle which corresponds to the at least one second section has a total central angle of 288 to 72 degrees.

12. The connection tube of claim 11, wherein the peripheral section of the first imaginary circle which corresponds to the at least one first section has a total central angle of 180 degrees, and the peripheral section of the first imaginary circle which corresponds to the at least one second section has a total central angle of 180 degrees.

13. The connection tube of claim 3, wherein the peripheral section of the second imaginary circle which corresponds to the at least one third section has a total central angle of 72 to 288 degrees, and the peripheral section of the second imaginary circle which corresponds to the at least one fourth section has a total central angle of 288 to 72 degrees.

14. The connection tube of claim 13, wherein the peripheral section of the second imaginary circle which corresponds to the at least one third section has a total central angle of 180 degrees, and the peripheral section of the second imaginary circle which corresponds to the at least one fourth section has a total central angle of 180 degrees.

15. The connection tube of claim 1, wherein when the connection tube is engaged with the sleeve tube of the power tool and the power tool operates to generate a reciprocating vibration in a predetermined direction, the at least one first section is at the predetermined direction, while the at least one second section is not at the predetermined direction.
